(19) United States
(12) Patent Application Publication
(10) Pub. No.: US 2006/0056626 A1
(43) Pub. Date: Mar. 16, 2006

(54) Method and system for selectively masking the display of data field values

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORPORATION (WM);C/O WEISS, MOY & HARRIS, P.C., 4204 NORTH BROWN AVENUE, SCOTTSDALE, AZ, 85251, US

(73) Assignee: International Business Machines Corporation, Armonk, NY (US)

(21) Appl. No.: 10/942,431

(22) Filed: Sep. 16, 2004

(51) Int. Cl. H04N 7/167; G06F 12/14

(52) U.S. Cl. 380/206; 726/16

(57) ABSTRACT

A method and system for selectively masking the display of data field values provides improved security and flexibility in computer data entry screens and dedicated terminals. A user input is received that selects a masked state of one or more data entry fields. When data is entered in a field, the masked state is used to determine whether to mask the data. The field may be a field in a web page, a dedicated application, an operating system interface or a dedicated terminal. The method and system may mask information that is typically not masked or may unmask information that is typically masked. The data entry fields may be entry fields for entering personal information within a web page and the user input may be a right mouse button click that generates a pop-up menu containing a selection for setting the masking state of a selected input field.

### BACKGROUND OF THE INVENTION

1. Technical Field

The present invention relates generally to graphical/textual user interfaces, and more specifically, to a method and system for selectively masking display of data field values in response to user input.

2. Description of the Related Art

Computer systems, in particular networked computer systems and recently the Internet and World-Wide-Web (WWW) have found increasing prominence in governments and business as well as personal lives. Internet browsers provide a user interface that connects the user with web sites at which purchases can be transacted, government and other organizational business can be conducted, as well as other applications in which transactions of secure data is involved. Further, dedicated terminals such as automated teller machines provide interfaces for funds transactions and are envisioned for use in other applications involving secure data.

When using a computer system or dedicated terminal, information is typically presented to a user on a graphical or textual display screen. The information presented by the system generally must be displayed, as the user will have no other way of seeing the graphical display output. However, when a printer is available, it is possible that such systems display sensitive information when it is unnecessary. Further, when the information that is displayed is input by the user, the user already knows the information and the graphical display is merely a reflection of the user input that provides the user with confirmation that the input was made as intended.

With passwords, the typical mechanism used to secure the entered information from “over-the-shoulder” observation is a technique known as masking. Masking typically hides the password by displaying a constant character such as an asterisk or random characters in the place of the characters typed by the user in the password entry field. The number of constant or arbitrary characters may or may not match the number of characters entered, and if the number does match, the system is providing at least a confirmation of the length of the entered information. However, such masking is typically practical only with respect to information both known to the user and stored within the system being accessed, or at least a shared key or hash relationship between the entered information and the stored information. As such, typographic entry errors are typically confirmed by the denial of access and the provision of repeated opportunity to enter the proper information. When information in a user information field is not known by the system a priori, then the user cannot receive confirmation from the system that the information was entered correctly unless displayed to the user. Therefore, entry fields that are provided for the input of new information typically are not masked.

Therefore, it would be desirable to provide a method and system for masking data display fields to protect sensitive entry information while also providing for display of the entered information to the user.

### SUMMARY OF THE INVENTION

The above objective of masking data display fields while also providing display of entered information is achieved in a method and system.

The method receives a first user input and in response to the first user input, sets a masking state of a previously-selected data entry field. The method also receives a second user input of information for entry in the selected data entry field and masks the information in conformity with the masking state that was set. The method may mask a field that is by default unmasked, or may unmask a field that is by default masked, such as a password or credit card number entry field. The first user input may toggle the field masking state or separate user input mechanisms maybe used to set and reset the masking state. Optionally, a group of fields may be masked or unmasked within a given frame or screen in response to the first user input. Alternatively, in lieu of the second user input, the method may mask a field that is providing an output to the user in conformity with the masking state.

The method may be embodied in a general-purpose computer system, a browser executing within a general-purpose computer system or a dedicated terminal. The method may also be embodied in a computer program product that encodes program instructions for carrying out the steps of the method.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram a general-purpose computer system in which an embodiment of the present invention may be practiced.

FIG. 2 is pictorial diagram depicting a web browser displaying a web page in accordance with an embodiment of the present invention.

FIG. 3 is a flowchart depicting operation of a system as embodied in a method in accordance with an embodiment of the invention.

FIG. 4 is a pictorial diagram depicting graphical output of a dedicated terminal in accordance with an embodiment of the present invention.

### DETAILED DESCRIPTION OF PREFERRED EMBODIMENT

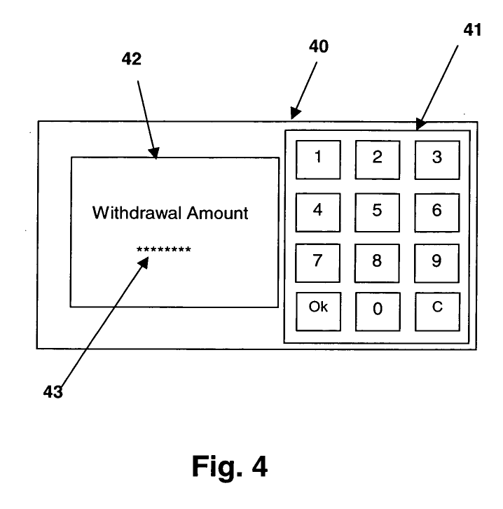

The present invention provides improved information security and privacy by providing selectable masking of data entry fields in a display to a user. In the exemplary embodiment, a web page accessed over the Internet via a web browser application is shown, but it should be understood that the present invention may be applied to other application programs intended for execution within a general or special purpose computer system, operating systems of such computer systems or dedicated terminals such as automated teller machines (ATMs) having a graphical or textual display device, a specific embodiment of which will be described below with reference to FIG. 4.

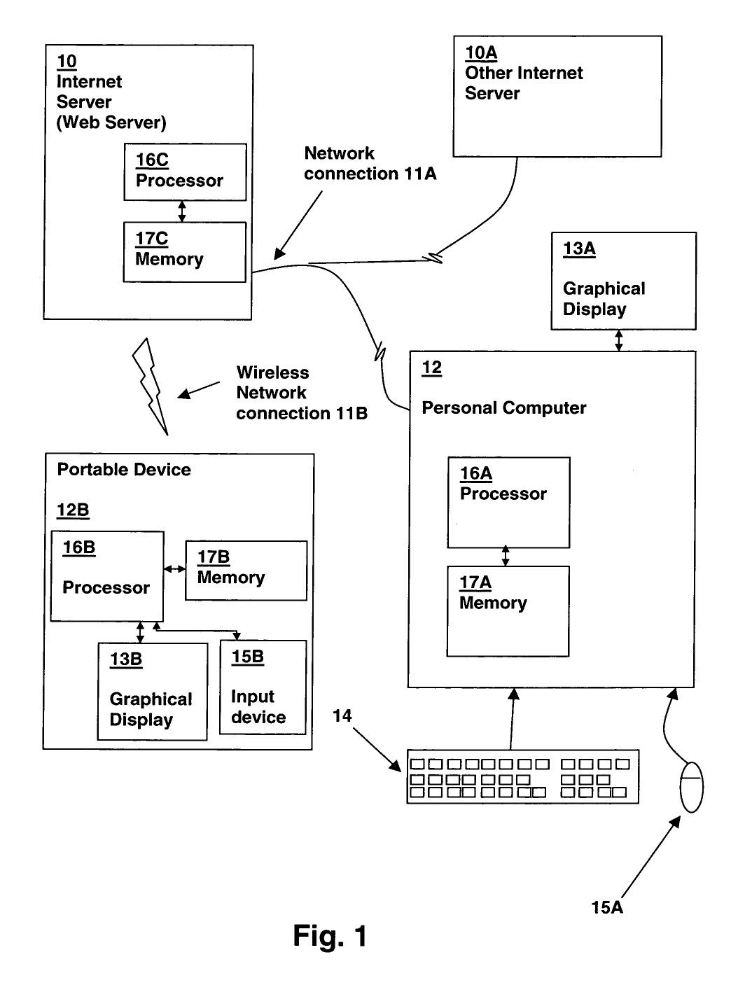

Referring now to the figures, and in particular to FIG. 1, a networked computer system within which embodiments of the present invention may be practiced is depicted in a block diagram. To support World Wide Web (WWW) surfing and other Internet functions an Internet server 10 is coupled to the Internet via a network connection 11A, along with other Internet servers such as server 10A. Internet server 10 includes a server processor 16C, coupled to a server memory 17C for executing server program instructions from server memory 17C. Also coupled to the Internet is a personal computer 12, having a processor 16A coupled to a memory 17A, for executing program instructions from memory 17A, wherein the program instructions include program instructions for executing a browser program method in accordance with an embodiment of the present invention.

Personal computer 12 is coupled to a graphical display 13A for displaying program output such as web browsers implementing embodiments of the present invention. Personal computer 12 is further coupled to input devices such as a mouse 15A and a keyboard 14 for receiving user input. The networked computer system may be coupled to a public network such as the Internet, or may be a private network such as the various “intra-nets” that are implemented within corporate offices and other installations requiring secure data communications.

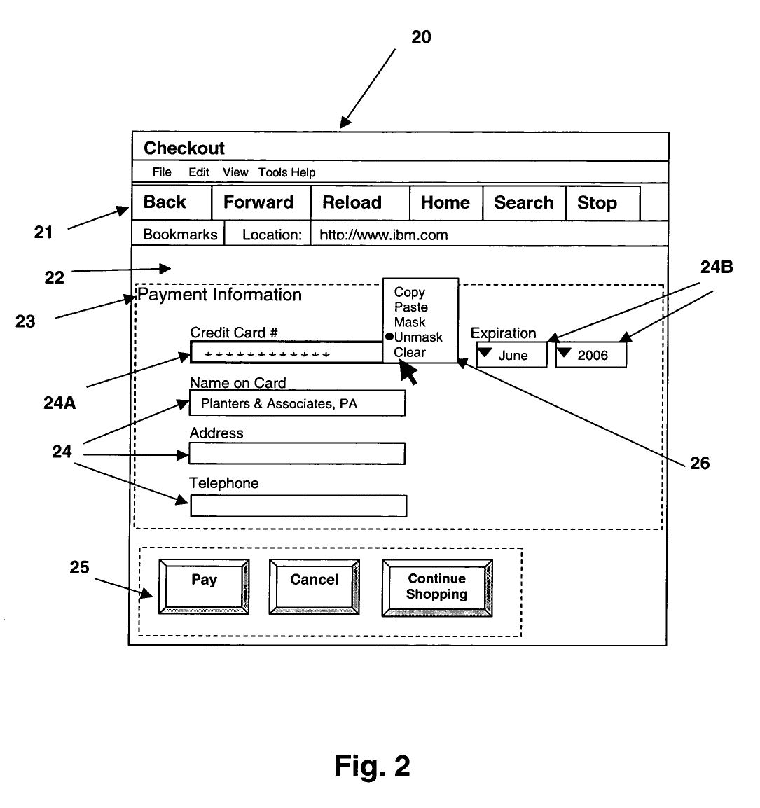

Within memory 17A, a network browser program (having output in the form of graphical display 20 of FIG. 2), in accordance with an embodiment of the present invention is executing and thereby providing access to the Internet via network connection 11A. Browser code embodying methods in accordance with embodiments of the present invention is executed by processor 16A. Personal computer 12 is included to provide a demonstrative example of a general purpose computer, and it will be understood by those skilled in the art that the techniques of the present invention apply to a variety of other applications such as dedicated Internet appliances, large mainframe computers having user terminals and programs and operating system interfaces other than web browsers.

The present invention also applies to personal appliances such as personal digital assistants (PDAS) and Internet-enabled pagers and cellular telephones, as well as to dedicated terminals such as ATMs and other kiosks. A second computing device, portable device 12B is shown coupled to Internet server 10 by a wireless network connection 11B. Portable device 12B may be a personal digital assistant (PDA) or another device adapted to provide a wireless and portable connection to the Internet (or other network), such as Internet-enabled cellular telephones, pagers, e-mail readers and the like. Portable device includes a processor 16B coupled to a memory 17B in which program instructions in accordance with an embodiment of the present invention are stored, whereby processor 16B executes program instructions implementing a method in accordance with an embodiment of the invention. A graphical display 13B and an input device 15B such as a keypad, stylus or touch-screen provide a user interface to portable device 12B.

Referring now to FIG. 2, a web browser 20 graphical display in accordance with an embodiment of the present invention is shown. Web browser 20 includes a control bar 21 for navigation and a web page display area 22 as generally provided in web browsers as well-known in the associated art. The implementation for a PDA or other portable device may be particularly adapted for the type of display and user input sensing available within the device. Within the web page depicted within web page display area 22, a sales payment form interface 23 as is generally provided by Internet merchandising sites is included, along with a series of controls (buttons) 25 for controlling the transaction. Fields 24 within form interface 23 provide for entry of personal information that the user may not wish displayed on graphical display 13A. In order to mask the display of data in a field, the user right-clicks on the field, which selects field 24A and causes a pop-up menu 26 to be generated on browser 20 display. The pop-up menu includes options for masking or unmasking data in the field, and as shown, the data entered within field 24A is masked and the user has the option of selecting the unmask option to display the data unmasked in field 24A. Data fields such as list boxes 24B may also have masking properties that can be selected so that when in a masked state, the selection values are only displayed prior to the user selecting a particular value if the list box field has a masking state that indicates the data should be masked. (The masking state can be selected as for typographic entry fields 24 and 24A.)

The illustrative examples are of masking being applied in situations where the input field is not typically masked in the prior art. The purpose is to provide security for the data entered in those fields from over-the-shoulder onlookers who might observe the entry of the sensitive information. The selectable masking state provides the user with the ability to quickly check the entered values, while permitting the values to be masked. However, as an alternative embodiment that may be provided in concert with the illustrated examples, data fields that are typically masked may be unmasked for testing/value confirmation purposes, such as when a user attempts to enter a password multiple times and the password is rejected. The alternative “unmasking” embodiment provides flexibility to the user when the user is not concerned that the information will be observed by an undesirable viewer.

Also, while the above description has illustrated a web browser in accordance with the present invention that implements the masking method of the present invention, it is possible to provide such functionality in concert with a standard network browser, either by programming the functionality in the web page itself via techniques such as javascript, java applets or other language features, or by providing an active document that implements a maskable field using an advanced document language/format such as extensible markup language (XML). As such, the description above applies additionally to documents, as XML and other documents do not have to form part of a website data exchange and may be edited and saved using a program familiar with the data format. However, it should be understood that such documents will eventually direct their viewer/editor program to execute program instructions as described herein and thus the document language used to code the maskable fields should be understood to constitute program instructions as described and claimed herein.

Other features that may be included within embodiments of the present invention include masking state persistence provided by cookies or other techniques, in which a field selected or masking is “remembered” by the browser or other application, so that the masking state is used when viewing the same page or document at a later time. Further, an option to set the masking character (e.g., blanks, asterisks or random) may be implemented. The use of blanks as an option is particularly useful when the user wishes to hide the fact that data has been entered at all.

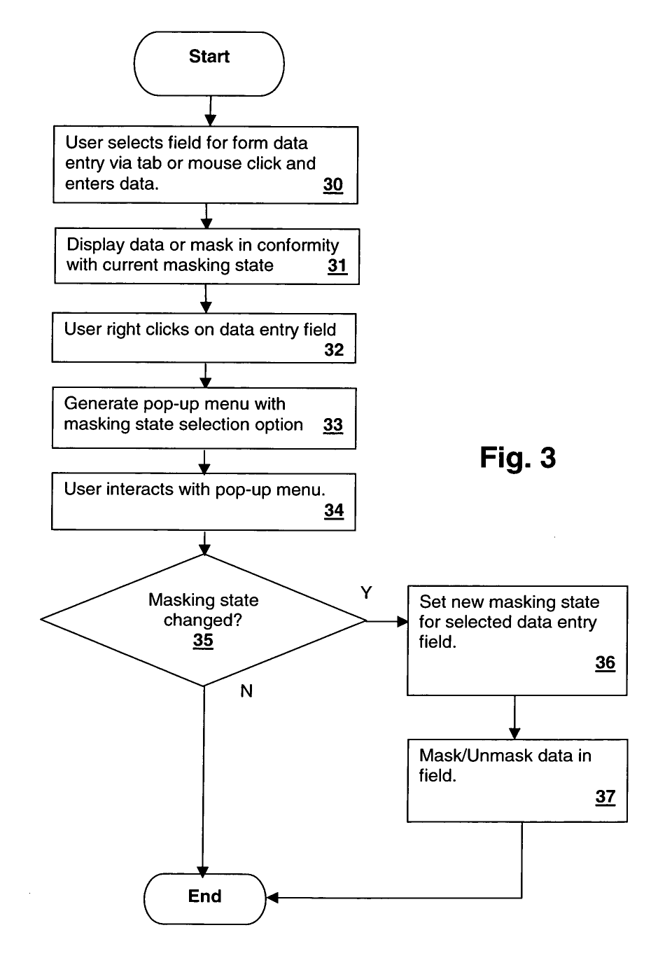

Referring now to FIG. 3, operation of a method in accordance with the present invention is depicted in a flowchart. When a user of Web Browser 20 selects a data input field in web page 22 and enters data (step 30) the data is displayed in conformity with the current masking state for that field (step 31). At any time, when the user right clicks on a data entry field (step 32) a pop-up menu is generated (step 33) that provides options for that field, including a masking state selection option if the field is maskable. The user interacts with pop-up menu 26 (step 34) and it the user has changed the masking state of the selected field (decision 35), then the new masking state is set for the selected data entry field (step 36) and the data in that field is masked or unmasked in conformity with the new masking state (step 37). It should be noted that the selection and data entry steps provided in step 30 and the display of data in Step 31 are illustrated for completeness and are not intended to limit the order of steps or the manner of selecting the field for which the masking state is selected. For example, a user may first edit a field masking state by initiating a right click on the field, simultaneously selecting the field and generating the pop-up menu before any data has been entered on the web page form. Also, the illustration of mouse activity and pop-up menus provides only an exemplary embodiment. The method and system of the present invention include keyboard commands to set/reset the masking state and/or to toggle the current masking state of a selected field. Keyboard-only operation of the present invention may be performed by tabbing through the fields (thus selecting them) and using a particular keystroke or combination thereof to alter the masking state of the field.

Referring now to FIG. 4, a user interface an ATM 40 in accordance with an embodiment of the present invention is depicted. ATM 40 includes a keypad 41 for receiving user input and a display device 42 for displaying text and graphics associated with a transaction. When a particular key combination is entered on keypad 41, fields that would normally be displayed such as withdrawal amount field 43 may be masked as shown.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for selectively displaying sensitive information within at least one data field of a visual display, comprising:
receiving a first user input;
setting a masking state of said at least one data field in response to said first user input;
receiving data for display in said at least one data field; and
selectively displaying said data on said visual display in conformity with said masking state.

2. The method of claim 1, wherein said visual display is a display of a form input graphical user interface comprising a plurality of user input fields, wherein an active one of said user input fields has a selectable masking state that is set in conformity with said first user input when said active input field is selected as an active field.

3. The method of claim 2, wherein said first user input is a right mouse button click.

4. The method of claim 3, further comprising:
receiving said right mouse button click;
responsive to receiving said right mouse button click, generating a pop-up menu that includes an option to select said masking state of said active input field;
receiving a second user input selecting said option; and
responsive to receiving said second user input, setting said masking state of said active input field.

5. The method of claim 4, wherein said plurality of user input fields are entry fields within a web page displayed on a browser executing within a general-purpose computer system, and wherein said entry fields are fields for entering sensitive personal information.

6. The method of claim 1, wherein said visual display is a screen display of a dedicated terminal, wherein said user input is an activation of one or more buttons on said dedicated terminal and wherein said method further comprises:
receiving an output targeted for said screen display; and
masking said output in conformity with said selected masking state.

7. The method of claim 6, wherein said output is one of a name of a user and a dollar amount of a transaction.

8. A computer system including a memory for storing program instructions and data, a processor coupled to said memory for executing said program instructions, a visual display coupled to said processor for displaying a user interface output and an input device coupled to said processor for providing a user interface input, wherein said program instructions within said general-purpose computer comprise program instructions for:
receiving a first user input;
setting a masking state of at least one data field of said user interface output in response to said first user input;
receiving data for display in said at least one data field; and
selectively displaying said data on said visual display in conformity with said masking state.

9. The computer system of claim 8, wherein said visual display is a display of a form input graphical user interface comprising a plurality of user input fields, wherein an active one of said user input fields has a selectable masking state that is set in conformity with said first user input when said active input field is selected as an active field.

10. The computer system of claim 9, wherein said first user input is a right mouse button click.

11. The computer system of claim 10, wherein said program instructions further comprise program instructions for:
receiving said right mouse button click;
responsive to receiving said right mouse button click, generating a pop-up menu that includes an option to select said masking state of said active input field;
receiving a second user input selecting said option; and
responsive to receiving said second user input, setting said masking state of said active input field.

12. The computer system of claim 11, wherein said plurality of user input fields are entry fields within a web page displayed on a browser executing within a general-purpose computer system, and wherein said entry fields are fields for entering sensitive personal information.

13. The computer system of claim 8, wherein said computer system is a dedicated terminal, wherein said visual display is a screen display of said dedicated terminal, and wherein said user input is an activation of one or more buttons on said dedicated terminal and wherein said program instructions further comprise program instructions for:
receiving an output targeted for said screen display; and
masking said output in conformity with said selected masking state.

14. The computer system of claim 13, wherein said output is one of a name of a user and a dollar amount of a transaction.

15. A computer program product comprising signal-bearing media encoding program instructions for execution within a computer system, wherein said program instructions comprise program instructions for:
receiving a first user input;
setting a masking state of at least one data field of said user interface output in response to said first user input;
receiving data for display in said at least one data field; and
selectively displaying said data on said visual display in conformity with said masking state.

16. The computer program product of claim 15, wherein said visual display is a display of a form input graphical user interface comprising a plurality of user input fields, wherein an active one of said user input fields has a selectable masking state that is set in conformity with said first user input when said active input field is selected as an active field.

17. The computer program product of claim 16, wherein said first user input is a right mouse button click.

18. The computer program product of claim 17, wherein said program instructions further comprise program instructions for:
receiving said right mouse button click;
responsive to receiving said right mouse button click, generating a pop-up menu that includes an option to select said masking state of said active input field;
receiving a second user input selecting said option; and
responsive to receiving said second user input, setting said masking state of said active input field.

19. The computer program product of claim 18, wherein said plurality of user input fields are entry fields within a web page displayed on a browser executing within a general-purpose computer system, and wherein said entry fields are fields for entering sensitive personal information.

20. The computer program product of claim 16, wherein said plurality of user input fields are entry fields within a document containing active directives corresponding to said program instructions for setting said masking state.
